(19) United States
(12) Patent Application Publication
(10) Pub. No.: US 2019/0078705 A1
(43) Pub. Date: Mar. 14, 2019

(54) REINFORCED THERMOPLASTIC DUCT

(71) Applicant: Technifab Incorporated, Avon, OH (US)

(72) Inventors: Bradley J. Bauchmoyer, Fairview Park, OH (US); Bruce D. Whitman, Lorian, OH (US)

(21) Appl. No.: 16/128,934

(22) Filed: Sep. 12, 2018

Related U.S. Application Data
(60) Provisional application No. 62/557,913, filed on Sep. 13, 2017.

(51) Int. Cl. F16L 9/128; B29C 65/00

(52) U.S. Cl. CPC F16L 9/128; B29C 66/7315; B29C 65/02; B29C 66/5221; B29C 66/73921

(57) ABSTRACT

A reinforced duct system includes at least a first thermoplastic duct section and a stiffening ring affixed to the first thermoplastic duct section. The stiffening ring includes first and second thermoplastic core rings, an inner reinforcement strip adhered to and spanning adjacent interior surfaces of the first and second core rings, an outer reinforcement strip adhered to and spanning adjacent exterior surface of the first and second core rings, and a flat reinforcement ring interposed between the first and second core rings.

### CROSS-REFERENCE TO RELATED APPLICATION

This application claims priority to U.S. Provisional Patent Application Ser. No. 62/557,913, filed on Sep. 13, 2017, for REINFORCED THERMOPLASTIC DUCT, the entire disclosure of which is fully incorporated herein by reference.

### BACKGROUND

Current negative pressure environmental control system ducts are constructed wholly of a composite laminate. This construction provides an adequate hoop strength to withstand negative differential pressure. In comparison to foam ducts, these composite ducts tend to be expensive, heavy, allow the capture of particulate matter that later enters the cabin, and often transmit unwanted noise.

Thermoplastic (e.g., thermoplastic foam) ducts offer the advantages of having a significantly lower weight, are inherently insulated, and are able to handle moderate levels of positive pressure. When internal duct pressure becomes lower than the external pressure (negative pressure), however, foam ducts tend to buckle, pinch, or otherwise contract, reducing the cross-sectional area of the duct and impeding fluid flow. While the wall thickness can be increased to handle a larger pressure differential, in conditions of significant negative pressure, the necessary increase in wall thickness for a foam duct may negate the weight savings over a composite duct, and may increase the size and/or cost of the resulting duct.

### SUMMARY

In an exemplary embodiment of the present application, a reinforced duct system includes at least a first thermoplastic duct section, and a stiffening ring affixed to the first thermoplastic duct section. The stiffening ring includes first and second thermoplastic core rings, an inner reinforcement strip adhered to and spanning adjacent interior surfaces of the first and second core rings, an outer reinforcement strip adhered to and spanning adjacent exterior surface of the first and second core rings, and a flat reinforcement ring interposed between the first and second core rings.

In another exemplary embodiment of the present application, a reinforced duct system includes a first thermoplastic duct section and a second thermoplastic duct section each having a first tensile/compression strength, and a stiffening ring thermally bonded between the first and second thermoplastic duct sections, the stiffening ring having a second tensile/compression strength greater than the first tensile/compression strength.

In another exemplary embodiment of the present application, a reinforced duct system includes a thermoplastic duct section having a first tensile/compression strength, and a stiffening ring adhered to one of an interior surface of the thermoplastic duct section and an exterior surface of the thermoplastic duct section, the stiffening ring having a second tensile/compression strength greater than the first tensile/compression strength.

According to another exemplary embodiment of the present application, in a method of constructing a reinforced duct system, a first thermoplastic duct section and a second thermoplastic duct section are provided, each having a first tensile/compression strength. A stiffening ring is thermally bonded between the first and second thermoplastic duct sections, the stiffening ring having a second tensile/compression strength greater than the first tensile/compression strength.

According to another exemplary embodiment of the present application, in a method of constructing a reinforced duct system, a thermoplastic duct section is provided, having a first tensile/compression strength, and a stiffening ring is adhered to one of an interior surface of the thermoplastic duct section and an exterior surface of the thermoplastic duct section, the stiffening ring having a second tensile/compression strength greater than the first tensile/compression strength.

In another exemplary embodiment of the present application, a duct stiffening ring includes first and second thermoplastic core rings, an inner reinforcement strip bonded to and spanning adjacent interior surfaces of the first and second core rings, an outer reinforcement strip bonded to and spanning adjacent exterior surfaces of the first and second core rings; and a flat reinforcement ring interposed between the first and second core rings.

According to another exemplary embodiment of the present application, in a method of constructing a duct stiffening ring, a flat reinforcement ring is interposed between adjacent ends of first and second thermoplastic core rings. An inner reinforcement strip is bonded to adjacent interior surfaces of the first and second core rings. An outer reinforcement strip is bonded to adjacent exterior surfaces of the first and second core rings.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention, wherein:

FIG. 1 is a perspective view of a reinforced thermoplastic duct, in accordance with an exemplary embodiment of the present application;

FIG. 2 is a perspective view of another reinforced thermoplastic duct, in accordance with another exemplary embodiment of the present application;

FIG. 3 is a cross-sectional side view of another reinforced thermoplastic duct, in accordance with another exemplary embodiment of the present application;

FIG. 4 is a perspective view of a duct stiffening ring, in accordance with an exemplary embodiment of the present application;

FIG. 5 is an end view of the duct stiffening ring of FIG. 4;

FIG. 5A is a cross-sectional view of the duct stiffening ring of FIG. 4, taken through the line A-A in FIG. 5; and

FIG. 5B is a cross-sectional view of another duct stiffening ring, in accordance with another exemplary embodiment of the present application.

### DETAILED DESCRIPTION

The present application is directed towards systems and arrangements in which conduits or vessels formed from thermoplastic materials (or other materials having a limited tensile and/or compressive strength) are reinforced with stiffening rings, to increase the hoop strength of the fluid retaining component, while minimizing or limiting the weight, size, or material costs of the component. While the exemplary embodiments described herein are primarily directed to stiffening ring reinforced circular thermoplastic foam ducts adapted for withstanding significant negative pressure differential environments, the inventive aspects described herein may additionally or alternatively be applied to other fluid containing components (e.g., conduits, vessels, plenums), other cross-sectional shapes (e.g., square, oval, etc.), other material components (e.g., other thermoplastic materials, fabrics), and fluid components intended for use in positive pressure conditions.

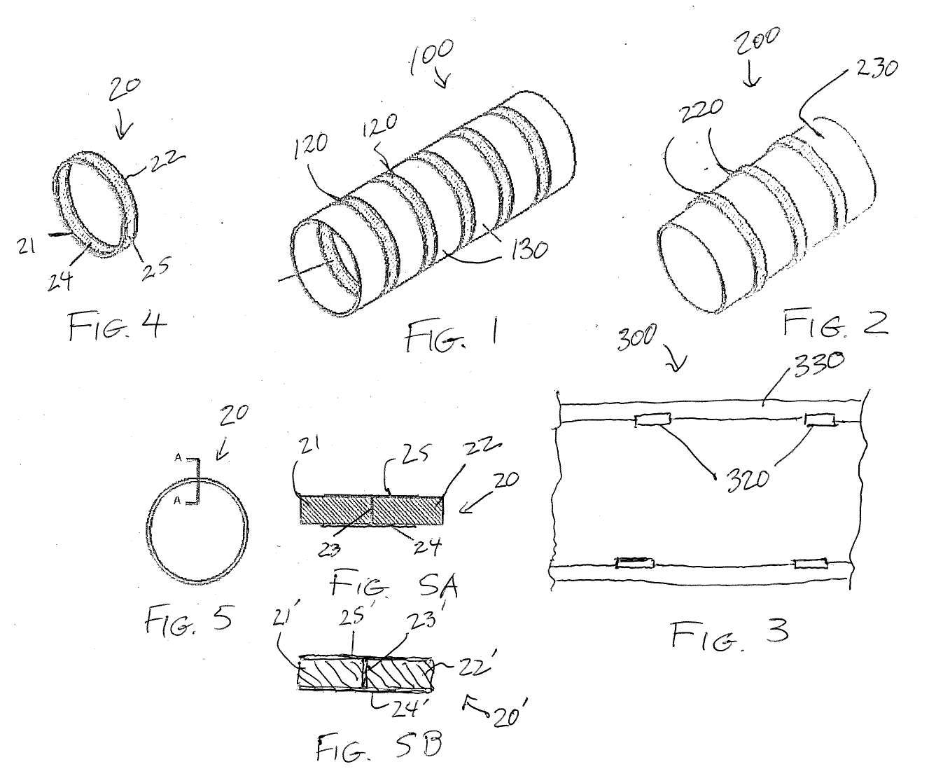

Stiffening rings may be attached to or integrated with a thermoplastic duct using a variety of suitable arrangements. In one exemplary embodiment, as shown in FIG. 1, stiffening rings 120 are bonded (e.g., thermally bonded, solvent bonded, adhesive bonded) between adjacent thermoplastic duct sections 130 to form a composite reinforced duct 100. In another exemplary embodiment, as shown in FIG. 2, stiffening rings 220 are secured or affixed (e.g., by adhesive, solvent bonding, thermal bonding, ultrasonic welding, etc.) around an outer surface of a thermoplastic duct section 230 to form a composite reinforced duct 200. In still another embodiment, as shown in FIG. 3, stiffening rings 320 are secured or affixed (e.g., by adhesive, solvent bonding, thermal bonding, ultrasonic welding, etc.) to an interior surface of a thermoplastic duct section 330 to form a composite reinforced duct 300.

While many different types of stiffening rings may be utilized to reinforce a thermoplastic duct, in an exemplary embodiment, a stiffening ring is formed from a thermoplastic core material (which may, but need not, be the same thermoplastic or thermoplastic foam material as the thermoplastic duct section to which the stiffening ring is to be secured or affixed) and one or more strips of high tensile/compression strength reinforcement material (e.g., fiberglass, Kevlar, carbon fiber prepreg) secured to the core material. This arrangement provides for relatively light weight reinforcing components having suitable insulation properties while providing adequate tensile/compression strength reinforcement.

FIGS. 4, 5, and 5A illustrate an exemplary composite stiffening ring 20 having first and second core rings 21, 22 joined to each other by a flat reinforcement ring 23 sandwiched or interposed between the first and second core rings 21, 22. An inner reinforcement strip or sleeve 24 is secured to an interior surface of the first and second core rings 21, 22, spanning the junction of the first and second core rings, and an outer reinforcement strip or sleeve 25 is secured to an exterior surface of the first and second core rings, spanning the junction of the first and second core rings. The core rings 21, 22 may be relatively thick compared to the reinforcement strips 24, 25—for example, with a thickness ratio between approximately 20:1 and approximately 80:1, or approximately 54:1 (or a core ring to combined inner/outer reinforcement thickness ratio thickness ratio between approximately 10:1 to approximately 40:1, or approximately 27:1). In an exemplary embodiment, reinforcement strips having a thickness of approximately 0.005 inches are applied to core rings having a thickness of approximately 0.270 inches.

In one embodiment, as shown in the cross-sectional view of FIG. 5A, the first and second core rings 21, 22 may extend beyond the edges of the inner and outer reinforcement strips 24, 25, for example, to facilitate thermal bonding of the core rings with adjacent duct sections 130, as shown in FIG. 1. In another embodiment, as shown in the cross-sectional view of FIG. 5B, the edges of either or both of the inner and outer reinforcement strips 24′, 25′ may substantially align with the outer edges of the first and second core rings 21′, 22′, for example, to facilitate securement of the stiffening ring 20′ to the exterior or interior surface of the of the thermoplastic duct section, as shown in FIGS. 2 and 3, respectively, by adhesion of the inner or outer reinforcement strips 24′, 25′ with the duct section. The flat reinforcement ring 23 may be sized to extend beyond the exterior and interior surfaces of the core rings 21, 22 (i.e., having an outer diameter larger than the outer diameter of the core rings, and an inner diameter smaller than the inner diameter of the core rings) to provide for bonding of an outer radial edge of the reinforcement ring 23 with the an interior surface of the outer reinforcement strip 25, and bonding of an inner radial edge of the reinforcement ring 23 with an exterior surface of the inner reinforcement strip 24.

In other embodiments (not shown), a stiffening ring may be formed from more than two core rings (e.g., 3-6 core rings), with flat reinforcement rings being interposed between adjacent edges of the additional core rings, for example, to provide additional increases in tensile/compression strength. These stiffening rings may, but need not, utilize core rings that are shorter in length, for example, to produce stiffening rings having a length comparable two the dual core ring stiffening rings described herein.

In an exemplary method of forming a stiffening ring, a strip of reinforcement material is wrapped around a mandrel (e.g., a cylindrical mandrel, or other suitable shape) to form the inner reinforcement strip or sleeve 24. First and second core rings 21, 22 are slid onto the mandrel and centered around the inner reinforcement strip 24, with a reinforcement ring 23 sandwiched or interposed between them. A strip of reinforcement material is wrapped around the first and second core rings 21, 22 to form the outer reinforcement strip or sleeve 25. The composite ring is then compression molded to form the finished stiffening ring 20, with the reinforcement ring 23 bonding with the reinforcement strips 24, 25.

The stiffening rings may be sized and positioned along the length of a composite duct to provide sufficient stiffening or hoop strength enhancement of the composite duct based on a variety of factors, including, for example, duct diameter, duct wall thickness, duct material, reinforcement sheet material, pressure rating, etc. For example, a thermoplastic duct having a diameter of approximately 4 inches and a wall thickness of approximately 0.270 inches may be provided with approximately 1 inch long stiffening rings at approximately 4 inch increments along the length of the composite duct. As another example, a thermoplastic duct having a diameter of approximately 8 inches and a wall thickness of approximately 0.270 inches may be provided with approximately 1 inch long stiffening rings, each formed from three core rings (as described above) at approximately 3 inch increments along the length of the composite duct. As still another example, a thermoplastic duct having a diameter of approximately 3 inches and a wall thickness of approximately 0.270 inches may be provided with approximately 1 inch long stiffening rings at approximately 5 inch increments along the length of the composite duct.

In embodiments including stiffening rings thermally bonded between sections of thermoplastic duct material, the stiffening ring may be provided with substantially the same inner and outer diameters as the duct section, such that no significant volume is added to the resulting composite thermoplastic duct. In other embodiments, the stiffening ring may be provided with an increased cross-sectional thickness to provide greater hoop strength and pressure capability for the composite duct. In one such embodiment, the stiffening ring may be provided with a larger outer diameter but substantially the same inner diameter, such that the interior surface of the duct is substantially uniform.

In embodiments including stiffening rings secured to the surface of a thermoplastic duct section, bonding may be accomplished through the use of self-adhesive reinforcing material strips, which may reduce the overall weight of the composite duct, and may minimize opportunities for bond failure. Alternatively, additional adhesives (e.g., film adhesive, epoxy, urethane-based adhesive) may be applied between the reinforcement strip and the duct section.

Stiffening rings secured to the surface of a thermoplastic duct section may be provided with a reduced thickness, as compared to the core rings, for example, to reduce duct size or to provide a more uniform duct interior (as shown in FIG. 3). Additionally or alternatively, the stiffening rings may be at least partially compressed into the duct section (for example, by compression molding, machining and adhesive bonding, etc.), to reduce the cross-sectional thickness of the composite duct (as shown in FIG. 3). Where the stiffening rings are secured to the interior surface of the duct section, such compression may improve uniformity of the duct interior.

Stiffening rings provided at intervals along the length of a composite thermoplastic duct may additionally or alternatively improve acoustic properties of the duct, for example, by reducing or impeding the propagation of sound wave vibrations along the length of the duct.

Other embodiments may provide for hoop strength enhancing or stiffening of a thermoplastic duct. As one example, a laminated duct having inner radial and outer radial duct sections may be provided with stiffening rings (e.g., the exemplary stiffening rings described above) molded or otherwise interposed between the inner radial and outer radial duct sections. As another example, a laminated duct having inner radial and outer radial duct sections may be provided with some other type of stiffening component (e.g., a web, grid, mesh honeycomb, or lattice material) molded or otherwise sandwiched between the inner radial and outer radial duct sections.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Parameters identified as “approximate” or “about” a specified value are intended to include both the specified value and values within 5% or 10% or 20% of the specified value, unless expressly stated otherwise. Further, it is to be understood that the drawings accompanying the present application may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

What is claimed is:

1. A reinforced duct system comprising:
at least a first thermoplastic duct section; and
a stiffening ring affixed to the first thermoplastic duct section, the stiffening ring comprising first and second thermoplastic core rings, an inner reinforcement strip adhered to and spanning adjacent interior surfaces of the first and second core rings, an outer reinforcement strip adhered to and spanning adjacent exterior surface of the first and second core rings, and a flat reinforcement ring interposed between the first and second core rings.

2. The reinforced duct system of claim 1, wherein the first thermoplastic duct section comprises thermoplastic foam.

3. The reinforced duct system of claim 1, wherein the first and second thermoplastic core rings comprise thermoplastic foam.

4. The reinforced duct system of claim 1, wherein at least one of the inner reinforcement strip, the outer reinforcement strip, and the flat reinforcement ring comprises at least one of fiberglass, Kevlar, and carbon fiber prepreg.

5. The reinforced duct system of claim 1, further comprising a second thermoplastic duct section, wherein the first thermoplastic core ring is bonded to the first thermoplastic duct section, and the second thermoplastic core ring is bonded to the second thermoplastic duct section.

6. The reinforced duct system of claim 5, wherein the first thermoplastic core ring is thermally bonded to the first thermoplastic duct section, and the second thermoplastic core ring is thermally bonded to the second thermoplastic duct section.

7. The reinforced duct system of claim 1, wherein the inner reinforcement strip is adhered to an exterior surface of the first thermoplastic duct section.

8. The reinforced duct system of claim 1, wherein the outer reinforcement strip is adhered to an interior surface of the first thermoplastic duct section.

9. The reinforced duct system of claim 1, wherein the first thermoplastic duct section and the stiffening ring are substantially circular in cross-section.

10. The reinforced duct system of claim 1, wherein the ratio of a thickness of the first and second thermoplastic core rings to a thickness of the inner and outer reinforcement strips is between approximately 20:1 and approximately 80:1.

11. The reinforced duct system of claim 1, wherein outer ends of the first and second thermoplastic core rings extend beyond corresponding outer ends of the inner and outer reinforcement strips.

12. The reinforced duct system of claim 1, wherein outer ends of the first and second thermoplastic core rings are substantially aligned with corresponding outer ends of the inner and outer reinforcement strips.

13. The reinforced duct system of claim 1, wherein an outer radial edge of the flat reinforcement ring is bonded to an interior surface of the outer reinforcement strip.

14. The reinforced duct system of claim 1, wherein an inner radial edge of the flat reinforcement ring is bonded to an exterior surface of the inner reinforcement strip.

15. A duct stiffening ring comprising:
first and second thermoplastic core rings;
an inner reinforcement strip bonded to and spanning adjacent interior surfaces of the first and second core rings;
an outer reinforcement strip bonded to and spanning adjacent exterior surfaces of the first and second core rings; and
a flat reinforcement ring interposed between the first and second core rings.

16. The duct stiffening ring of claim 15, wherein the first and second thermoplastic core rings comprise thermoplastic foam.

17. The duct stiffening ring of claim 15, wherein at least one of the inner reinforcement strip, the outer reinforcement strip, and the flat reinforcement ring comprises at least one of fiberglass, Kevlar, and carbon fiber prepreg.

18. The duct stiffening ring of claim 15, wherein the stiffening ring is substantially circular in cross-section.

19. The duct stiffening ring of claim 15, wherein the ratio of a thickness of the first and second thermoplastic core rings to a thickness of the inner and outer reinforcement strips is between approximately 20:1 and approximately 80:1.

20. A method of constructing a reinforced duct system, the method comprising:
providing a first thermoplastic duct section and a second thermoplastic duct section each having a first tensile/compression strength; and
thermally bonding a stiffening ring between the first and second thermoplastic duct sections, the stiffening ring having a second tensile/compression strength greater than the first tensile/compression strength.
